(19) United States
(12) Patent Application Publication
(10) Pub. No.: US 2015/0156192 A1
(43) Pub. Date: Jun. 4, 2015

(54) FEDERATED IDENTITY CREATION

(71) Applicants: Jun Yang, San Jose, CA (US); Zhenyin Yang, Saratoga, CA (US); Steven Romero, Portland, OR (US); Anthony Shah, Santa Clara, CA (US); Ladd Van Tol, Portland, OR (US)

(72) Inventors: Jun Yang, San Jose, CA (US); Zhenyin Yang, Saratoga, CA (US); Steven Romero, Portland, OR (US); Anthony Shah, Santa Clara, CA (US); Ladd Van Tol, Portland, OR (US)

(73) Assignee: EBAY INC., SAN JOSE, CA (US)

(21) Appl. No.: 14/094,929

(22) Filed: Dec. 3, 2013

(51) Int. Cl. H04L 29/06

(52) U.S. Cl. CPC H04L 63/0815

(57) ABSTRACT

A user may have multiple identities used to access multiple services or accounts. The user may use the multiple identities online from a device. The system may detect that the multiple identities connect from the device and determine that the multiple online identities all have associated relationships with the user. A federated user identifier may, accordingly, be created. Based on the common identification, various features may be enabled, including fraud detection and targeted advertising.

### TECHNICAL FIELD

The subject matter disclosed herein generally relates to user accounts in electronic systems. Specifically, in one example, the present disclosure provides a federated mobile identity for multiple user accounts. The subject also relates to systems, methods and media for creating federated user identities.

### BACKGROUND

A user may have one electronic identity associated with one or more online services and a different electronic identity associated with other online services. Under some circumstances, a user may have multiple electronic identities associated with the same online service. Each online service may, separately, gather information about the user and the user's corresponding electronic identity.

### BRIEF DESCRIPTION OF THE DRAWINGS

Some embodiments are illustrated by way of example and not limitation in the figures of the accompanying drawings.

FIG. 1 is a block diagram illustrating an example of a network environment for implementing particular disclosed embodiments.

FIG. 2 is a block diagram illustrating components of a service providing machine for implementing particular disclosed embodiments.

FIG. 3 is a block diagram illustrating components of a mobile identity machine for implementing particular disclosed embodiments.

FIGS. 4-8 are block diagrams illustrating data relationships in particular disclosed embodiments.

FIG. 9 is a flowchart illustrating operations of a device in performing particular disclosed embodiments.

FIG. 10 is a block diagram illustrating an example computer system architecture.

### DETAILED DESCRIPTION

Example methods and systems are directed to determining that a single user is accessing multiple computer accounts. In one example, a system identifies different user and device identities all relating to the same user, and identifies relationships between these user and device identities. A unique federated identity is created for the user utilizing at least portions of the user and device identities, or at least some of the identified relationships.

Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. However, it will be evident to one skilled in the art that the present subject matter may be practiced without these specific details.

A user may have multiple accounts with multiple computer-provided services. That the multiple accounts are all associated with the user may be determined by recognizing patterns in the way the multiple accounts are accessed. For example, a connection from a single mobile phone to accounts on multiple services may suggest that each of those connections originates from a single user since a single individual typically uses mobile phones. Other example embodiments may determine user identity based on commonality of transactions or assets or other criteria.

A service provider may communicate with an identity provider to request additional information about the user corresponding to the user account of the service provider, to provide information about the account, or both. The identity provider may respond with additional information about the user, store the information about the account, or both.

In some examples, systems, methods and media are provided that aid in discovering user identities (for example, accounts from multiple business properties or companies) and device identities (for example, mobile smart phones, tablet computers and person computers), and help in establishing relationships among such identities. A unique federated identity is created to represent a graph of inter-related identities for each user.

In some examples, a common unique device identifier is provided for mobile devices. A mechanism is designed and implemented (for example, in iOS or Android operating systems) to generate and use a common device identifier that is shared by multiple mobile applications (“apps”) running on the same device with controlled life cycle management. User accounts used in multiple apps can be associated with each other through the common device identifier. By logging and analyzing activities incurred on mobile devices within each app, associations (or relationships) between user accounts and devices can be identified and, in some examples, these can further derive relationships between other user accounts.

In some examples, many associated user accounts and devices can be included in a graph that represents the comprehensive profile of the account, device or owner (or all three) and the relationships across, for example, multiple business entities or adjacencies. In some examples, a federated identity is created to represent the identity of the graph (i.e. user profile, or person). This federated identity, for example, can be used in user personalization and engagement operations. In one such example, a user profile can be built from many activities on multiple accounts and devices of a user, thus, creating a more complete user profile (graph) for better personalization efforts. In promoting user engagement, for example, real time events occurring in or on a single account or device can be used as a signal to all other accounts included in the same identity graph. In a multi-device experience (or session), the profile graph includes data about all (at least many) of the devices used by a user; therefore, the graph itself or the unique federated identifier associated with it can be used to allow for a more seamless multi-device experience.

In some examples, targeted information or other content can be presented via a mobile device. More generally, such information may be presented via an “interface”. An interface can exist in many forms. For example, the interface may interact with a user in a functional or physical way, and may contribute and/or consume content. The interface mayor may not be associated with a device. The interface may be mouse driven, voice driven, or touch driven, for example. An associated device may or may not be network enabled. The device or interface may be associated with local or proximate processing capability. In some examples, a physical interface may be presented by “smart” glasses (for example, Google glasses). In other embodiments, an interface may be an intangible, such as a hologram. In further examples, the interface may be may be a non-mobile surface, such as a wall, table top, or side of an appliance. In other examples, an interface may be provided in a kiosk, or by a surface or device inside a motor vehicle, for example.

In some examples, targeted information or other content may be associated with a “location determination” of a user. This term includes detecting a user's presence or location. It may involve active sensing (for example, an accelerometer or other sensor) or a passive identification (for example, RFID). Location identification can be used as a trigger to present targeted information or other content in an interface

Targeted information or other content may include “consumable” information or “non-consumable” information (for example, metadata). Consumable examples can be displayed, emailed, pushed, or included in a text message. The information may include tiles, social media, digital data, physical (billboard) embodiments, audio files, commercial art, smart advertisements and so forth.

A “device” is any physical object that is capable of being a communication device or can present an interface. The device may be associated with local computational or remote computational functionality.

In some examples, targeted information may include “ad content”. Ad content may include promotional information that characterizes this information from general content. A “promotion” in ad content need not be tied to commerce, or payment, or a transaction, but will usually be associated with receipt of some kind of value. The value could relate to a good or a service (or hybrid of the same).

The presentation of the targeted information may seek to extend online user “sessions.” In a multi-device world, the conventional definition of a session is becoming increasingly inapplicable. Viewed more broadly, a session in this disclosure includes the idea that the user is trying to achieve a particular task, with that task potentially spread over multiple devices and extended time periods. The user could pick up a session on a different device or after a lapse of time, and so forth. A user could have many parallel sessions going on simultaneously, for example. A session may include user phases, such as a discovery phase, an exploratory phase, a follow-up phase, and so forth. Sessions may be assessed or tied to a success metric, such as a “Bid-Buy-Offer-Watch-Ask seller question” (BBOWA) metric, for example.

Thus, in some embodiments, a method comprises identifying, using a processor of a machine, a first user authentication comprising a first user identifier; identifying a second user authentication comprising a second user identifier different from the first user identifier; determining that the first user identifier and the second user identifier both correspond to a first user; and creating a unique federated identifier for the first user based on a relationship between the first user identifier and the second user identifier.

In some embodiments, a system may comprise a memory; a communication module to identify a first user authentication comprising a first user identifier; identify a second user authentication comprising a second user identifier different from the first user identifier; and an identification module to determine, using a processor of a machine, that the first user identifier and the second user identifier both correspond to a first user; and create a unique federated identifier for the first user based on a relationship between the first user identifier and the second user identifier.

In some embodiments, a non-transitory machine-readable medium may comprise instructions that, when executed by one or more processors of a machine, cause the machine to perform operations comprising identifying, using a processor of a machine, a first user authentication comprising a first user identifier; identifying a second user authentication comprising a second user identifier different from the first user identifier; determining that the first user identifier and the second user identifier both correspond to a first user; and creating a unique federated identifier for the first user based on a relationship between the first user identifier and the second user identifier.

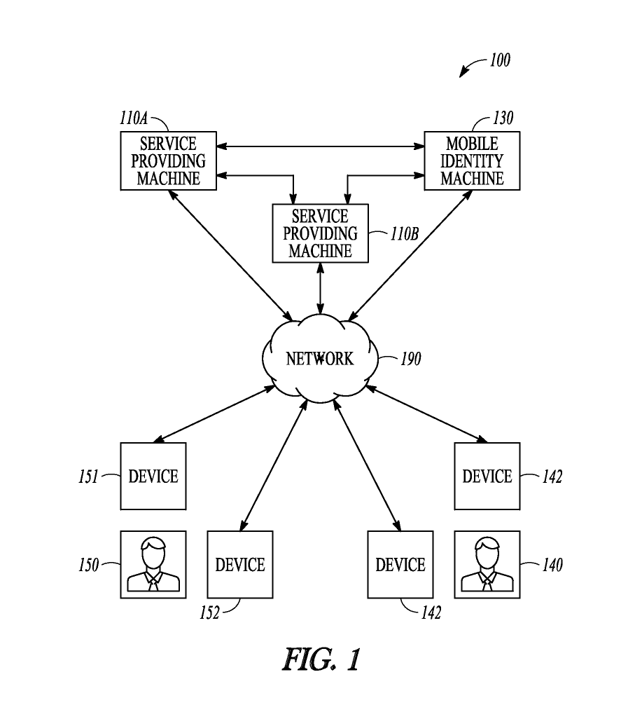

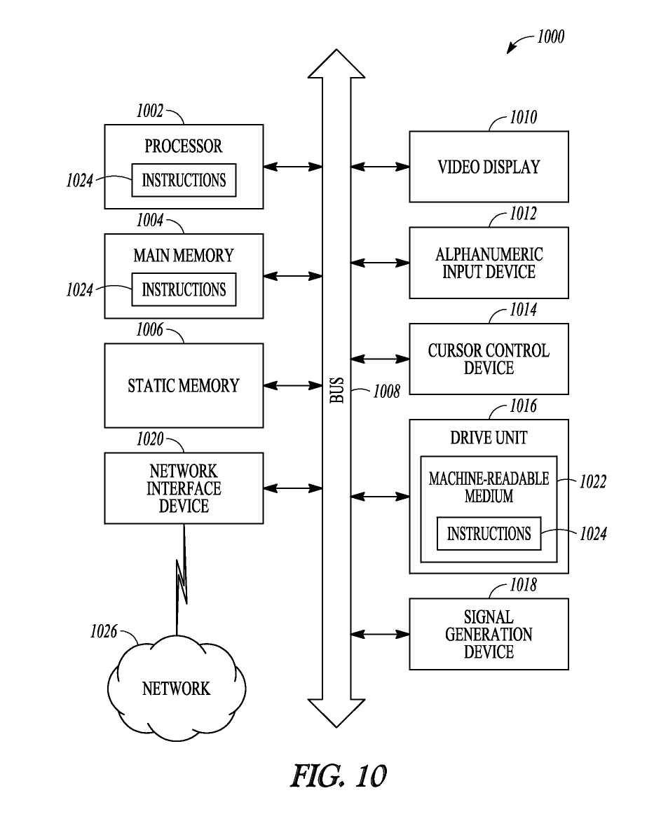

Turning now to the accompanying drawings, FIG. 1 is a block diagram illustrating an example of a network environment for implementing particular disclosed embodiments. The network environment 100 includes a service providing machine 110a, a service providing machine 110b, a mobile identity machine 130, and devices 141, 142, 151, and 152, all communicatively coupled to each other via a network 190. The service providing machines 110a and 110b, the mobile identity machine 130, and the devices 141, 142, 151, and 152 may each be implemented in a computer system, in whole or in part, as described below with respect to FIG. 10.

The devices 141, 142, 151, and 152 may be used by the users 140 and 150 to access services provided by the service providing machines 110 (e.g., the service providing machine 110a and the service providing machine 110b). The service providing machines 110a and 110b may provide services such as financial or banking services, social networking services, retail or wholesale services, communication services, real property management or other official registries, or other services. The service providing machines 110a and 110b may access the mobile identity machine 130 to gather additional information about the users 140 and 150, to provide information about the users 140 and 150, or both.

For example, the user 150 may access the service providing machine 110a using the device 151. The service providing machine 110a may then inform the mobile identity machine 130 of the access and request information from the mobile identity machine 130. The mobile identity machine 130 may not have any information about the user 150 and informs the service providing machine 110a of this. The user 150 may then access a second service providing machine 110b using the device 151. The second service providing machine 110b may then inform the mobile identity machine 130 of the access and request information from the mobile identity machine 130. The mobile identity machine 130 may inform the second service providing machine 110b of the previous access from the same device 151 to the first service providing machine 110a. Based on this information, the second service providing machine 110b may alter the services provided to the user 150. For example, products offered or advertisements presented may be altered based on the information provided by the mobile identity machine 130. As a more specific example, if the first service providing machine 110a provides a service relating to a particular sport and the second service providing machine 110b provides a retail service, the second service providing machine 110b may provide advertisements related to the sport for the user 150 that uses both services. In some example embodiments, the second service providing machine 110b may also communicate with the first service providing machine 110a to gather additional information regarding the user 150.

In another example, the user 150 may access a service providing machine 110a or 110b using the device 151. The service providing machine 110a or 110b may then inform the mobile identity machine 130 of the access and request information from the mobile identity machine 130. The mobile identity machine 130 may not have any information about the user 150, and informs the service providing machine 110a or 110b of this. The user 150 may then access the service providing machine 110a or 110b using the device 152. The service providing machine 110a or 110b may then inform the mobile identity machine 130 of the access and request information from the mobile identity machine 130. The mobile identity machine 130 may inform the service providing machine 110a or 110b of the previous access from the different device 151 to the service providing machine 110a or 110b. Based on this information, the service providing machine 110a or 110b may alter the services provided to the user 150. For example, products offered or advertisements presented may be altered based on the information provided by the mobile identity machine 130. As a more specific example, connecting from multiple devices may correlate with a certain economic status, and advertisements may be more narrowly targeted based on this.

One or both of the users 140 and 150 may be a human user, a machine user (e.g., a computer configured by a software program to interact with one or more of the devices 141, 142, 151, and 152), or any suitable combination thereof (e.g., a human assisted by a machine or a machine supervised by a human). The user 140 is not part of the network environment 100, but is associated with the devices 141 and 142 and may be a user of the devices 141 and 142. For example, the devices 141 and 142 may each be a desktop computer, a vehicle computer, a tablet computer, a navigational device, a portable media device, or a smart phone belonging to the user 140. The device 141 or 142 may include or simply be comprised by a user interface as defined above. Likewise, the user 150 is not part of the network environment 100, but is associated with the devices 151 and 152. As an example, the devices 151 and 152 may each be a desktop computer, a vehicle computer, a tablet computer, a navigational device, a portable media device, or a smart phone belonging to the user 150.

Any of the machines, databases, or devices shown in FIG. 1 may be implemented in a general-purpose computer modified (e.g., configured or programmed) by software to be a special-purpose computer to perform the functions described herein for that machine, database, or device. For example, a computer system able to implement any one or more of the methodologies described herein is discussed below with respect to FIG. 10. As used herein, a “database” is a data storage resource and may store data structured as a text file, a table, a spreadsheet, a relational database (e.g., an object-relational database), a triple store, a hierarchical data store, or any suitable combination thereof. Moreover, any two or more of the machines, databases, or devices illustrated in FIG. 1 may be combined into a single machine, and the functions described herein for any single machine, database, or device may be subdivided among multiple machines, databases, or devices.

The network 190 may be any network that enables communication between or among machines, databases, and devices (e.g., the service providing machines 110a or 110b and the mobile identity machine 130). Accordingly, the network 190 may be a wired network, a wireless network (e.g., a mobile or cellular network), or any suitable combination thereof. The network 190 may include one or more portions that constitute a private network, a public network (e.g., the Internet), or any suitable combination thereof.

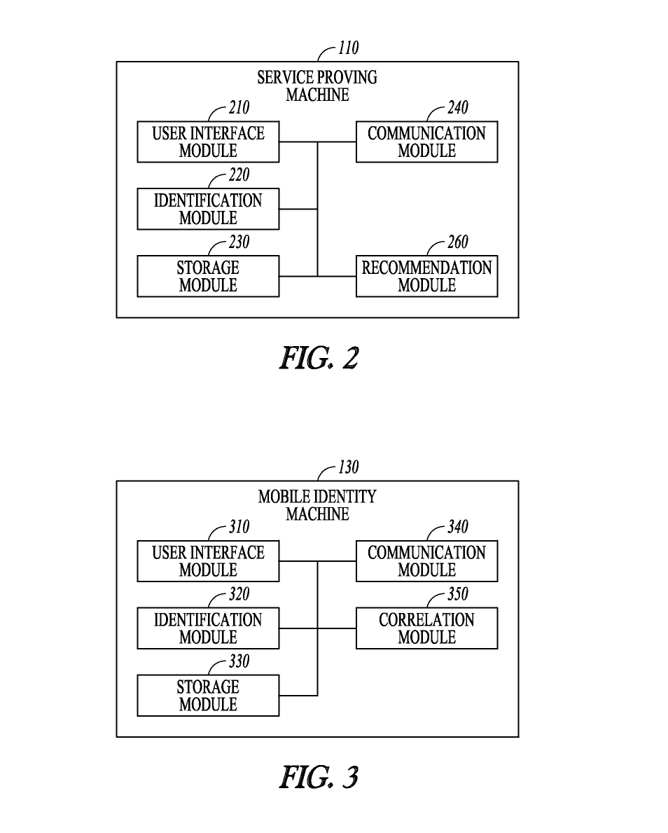

FIG. 2 is a block diagram illustrating components of a service providing machine 110a or 110b for implementing particular disclosed embodiments. The service providing machine 110a or 110b is shown as including a user interface module 210, an identification module 220, a storage module 230, a communication module 240, and a recommendation module 260, all configured to communicate with each other (e.g., via a bus, shared memory, or a switch). Any one or more of the modules described herein may be implemented using hardware (e.g., a processor of a machine) or a combination of hardware and software. For example, any module described herein may configure a processor to perform the operations described herein for that module. Moreover, any two or more of these modules may be combined into a single module, or be referred to by alternate names, and the functions described herein for a single module may be subdivided among multiple modules. Furthermore, according to various example embodiments, modules described herein as being implemented within a single machine, database, or device may be distributed across multiple machines, databases, or devices.

The user interface module 210 may be configured to provide a user interface to a user 140 or 150 connecting to the service providing machine 110a or 110b. For example, the service providing machine 110a or 110b may serve a web page. The user 140 or 150 may respond to the user interface by an authentication that may include logging in (e.g., with a user name and password). The login information provided by the user 140 or 150 may be stored by the storage module 230 and used to identify the user 140 or 150 by the identification module 220. The communication module 240 may then communicate information about the user 140 or 150 to the mobile identity machine 130, and receive information about the user 140 or 150 in response. The recommendation module 260 may then provide recommendations to the user 140 or 150 or otherwise alter the user experience based on the additional information received by the communication module 240.

FIG. 3 is a block diagram illustrating components of a mobile identity machine 130 for implementing particular disclosed embodiments. The mobile identity machine 130 is shown as including a user interface module 310, an identification module 320, a storage module 330, a communication module 340, and a correlation module 350, all configured to communicate with each other (e.g., via a bus, shared memory, or a switch). Any one or more of the modules described herein may be implemented using hardware (e.g., a processor of a machine) or a combination of hardware and software. For example, any module described herein may configure a processor to perform the operations described herein for that module. Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices.

The user interface module 310 may be configured to provide a user interface to a user 140 or 150 connecting to the mobile identity machine 130. For example, the mobile identity machine 130 may serve a web page to an administrative user. The administrative user may respond to the user interface by an authentication that may include logging in. The administrative user may be able to view the user identities stored by the storage module 330, modify the data, change which aspects of the data are available to different service providers, etc. For example, the service providers may pay a fee to the mobile identity service and, depending on the amount of the fee paid, the mobile identity service may provide more or less information regarding the user. In some example embodiments, an administrator may control these settings using a user interface presented by the user interface module 310.

The communication module 340 may communicate with one or more of the service providing machines 110a or 110b to send and receive information regarding users 140 or 150. The identification module 320 may then, using the correlation module 350, determine the identity of the user 140 or 150 accessing the service providing machine 110a or 110b. Information regarding the user 140 or 150 may be stored by the storage module 330, and accessed by the correlation module 350 and the identification module 320 in the process of identifying the user 140 or 150.

In some examples, the communication module 240 or 340 can identify a first user authentication comprising a first user identifier, and identify a second user authentication comprising a second user identifier different from the first user identifier. The identification module 220 or 320 can determine, using a processor of a machine, that the first user identifier and the second user identifier both correspond to a first user, and create a unique federated identifier for the first user based on a relationship between the first user identifier and the second user identifier.

In some examples, the identification module 220 or 330 can further include at least a portion of the first user identifier and the second user identifier in the unique federated identifier for the first user. The first user identifier may be associated with a user account number or property identifier, and the second user identifier may include a user device identifier. In some examples, determining that the first user identifier and the second user identifier both correspond to the first user is based on receiving both the first user identifier and the user device identifier from the device.

In some examples, the first user authentication is for a first service or account and the second user authentication is for a second service or account. In some examples, the communication module 240 or 340 is able to receive a first user preference associated with the first or second user authentication, and the identification module 220 or 320 is able to apply the first user preference to a service associated with the second user authentication based on a determination that the first user identifier, the second user identifier, or the unique federated identifier corresponds to the first user.

In some examples, the communication module 240 or 340 is further to identifying a first user preference associated with the first user, and the identification module 220 or 320 is able to use the unique federated identifier in causing the presentation to the first user of targeted content based on the identified first user preference.

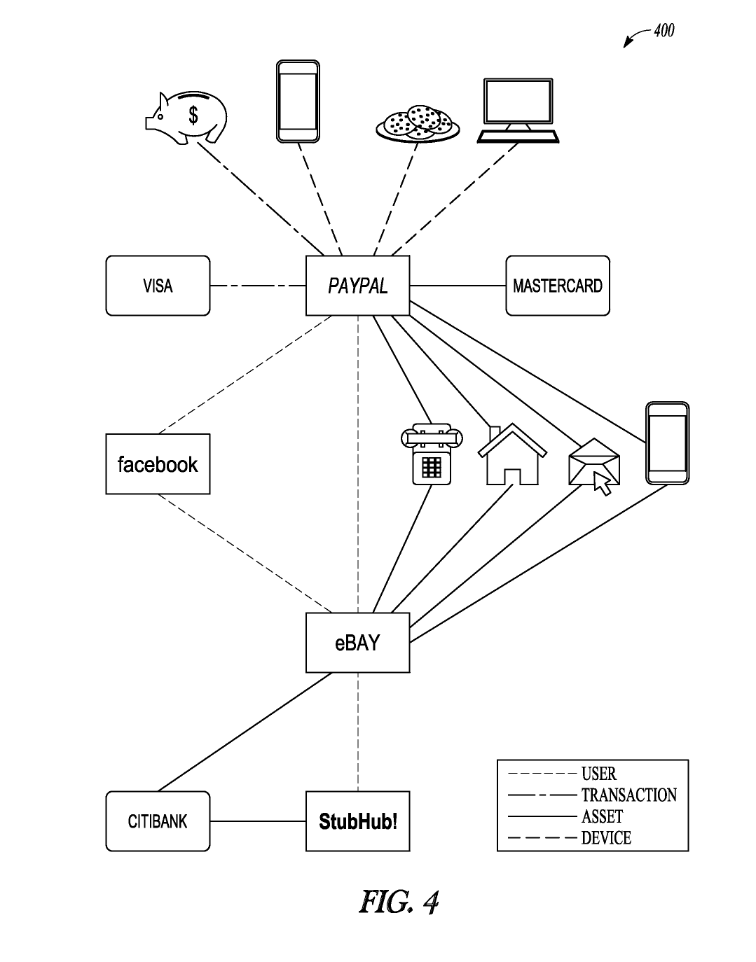

FIG. 4 is a diagram illustrating data relationships (graph types) in particular disclosed embodiments. The web of relationships 400 may be used to establish a single identity for a user based on multiple relationships between the user and various services. For example, device relationships are shown between PayPal and each of a mobile device, a cookie (stored on a device), and a computer. When a single account is accessed from multiple devices, each of those devices may be associated with the user of the account.

Also shown are transaction relationships between PayPal and each of a savings account and a Visa card. When a single account transfers funds from multiple financial accounts, each of those accounts may be associated with the user of the account.

The third type of relationship shown is the asset relationship. Each of a phone number, an address, an email address, and a mobile phone number has an asset relationship with both PayPal and eBay. Additionally, a credit card has an asset relationship with PayPal, and a credit card has an asset relationship with eBay and StubHub. When separate user accounts have overlapping contact or financial information, the separate user accounts may be associated with a single user.

The fourth type of relationship shown is the user relationship. Facebook is shown as having a user relationship with PayPal and eBay, while StubHub also has a user relationship with eBay. When a single user account is used to access multiple services, information gathered about the user account by each service may be combined to form a more complete mobile identity for the user.

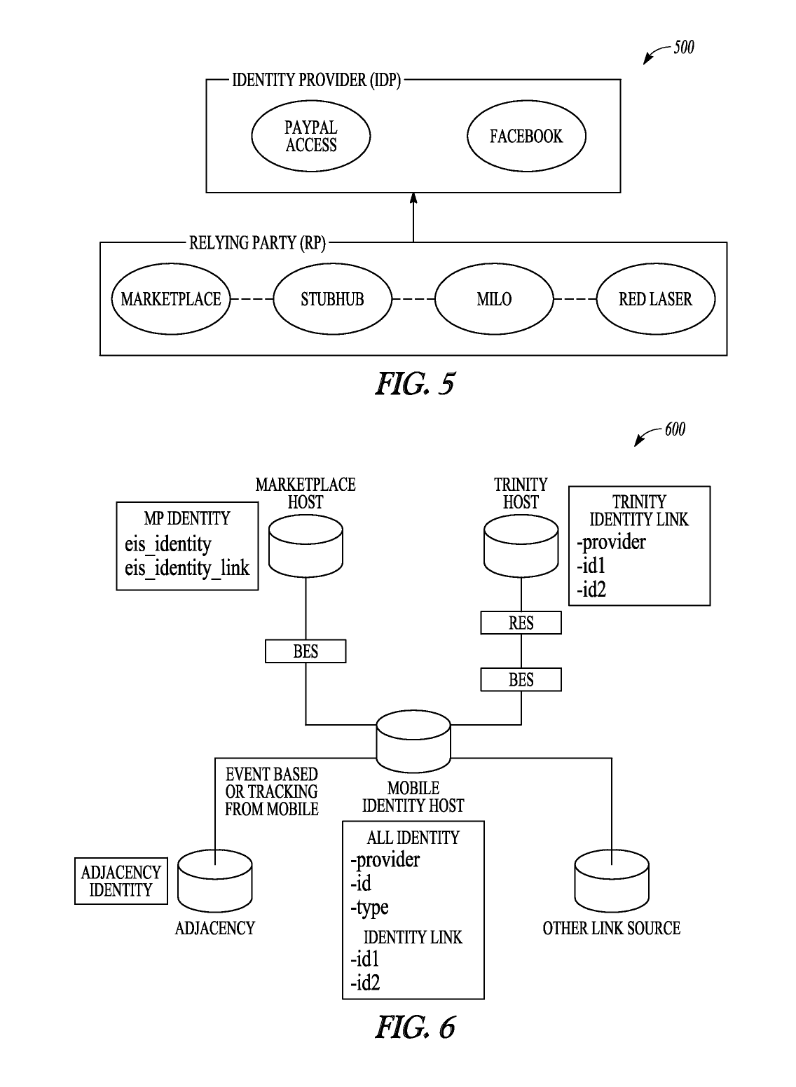

FIG. 5 is a block diagram illustrating data relationships in particular disclosed embodiments. FIG. 5 shows an example embodiment in a network 500 in which each of Marketplace, Stubhub, Milo, and Red Laser comprises an example of the service providing machines 110a or 110b, and each of PayPal Access and Facebook comprises an example of the mobile identity machine 130. In this example embodiment, each of the relying parties (e.g., Marketplace, Stubhub, Milo, or Red Laser) communicates with one or both of the identity providers (e.g., PayPal Access or Facebook) to share user information. The identity providers may communicate with each other to share the user information they have gathered from the relying parties communicating with them. The relying parties may communicate with each other to share user information corresponding to a user identity retrieved from one or more of the identity providers.

FIG. 6 is a block diagram illustrating data relationships in particular disclosed embodiments. FIG. 6 shows an example embodiment in a network 600. The mobile identity host (e.g., a mobile identity machine 130) may communicate with the trinity host (e.g., a second mobile identity machine 130) and gather information regarding the provider and the two identities for the user. The marketplace host (e.g., a service providing machine 110a or 110b) may communicate with the mobile identity host and provide information regarding the user gathered in the marketplace. The mobile identity host may also gather information based on adjacency, or the use of the same device to access multiple accounts. Additional linking information for the user may also be gathered from another linked source. Accordingly, the mobile identity host may gather a set of information about the user, such as a provider, identifier, and type. The mobile identity host may also gather a set of user ids (e.g., user names, account numbers, etc.) used by the user to access various services. As a result, one of the other hosts may access the mobile identity host and access the information stored therein regarding the user based on providing the user id used to access the mobile identity host. In other example embodiments, additional information regarding the user may be provided.

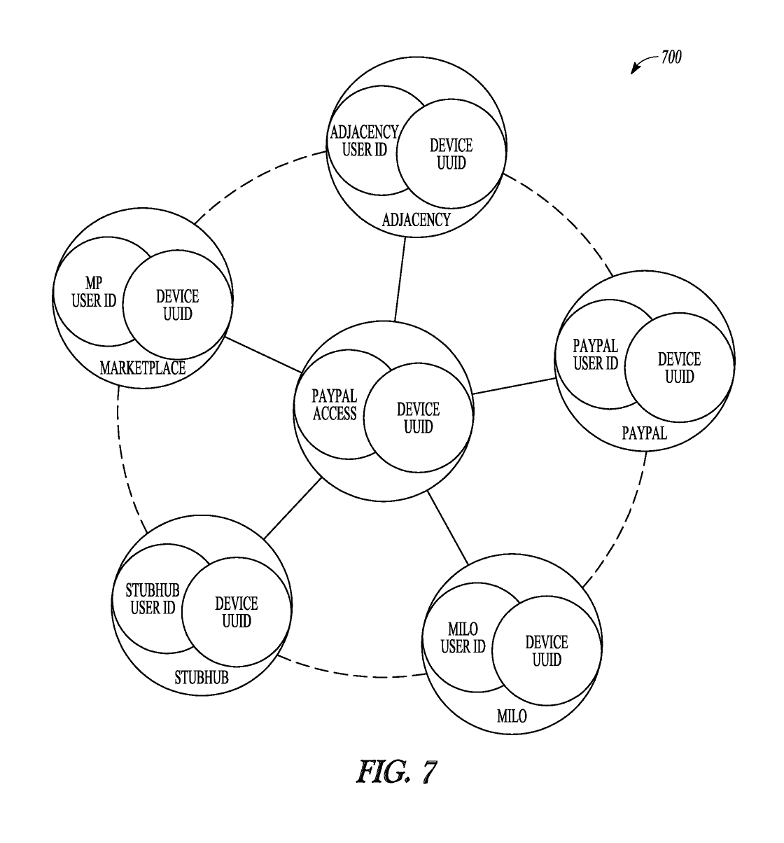

FIG. 7 is a block illustrating data relationships in particular disclosed embodiments. FIG. 7 shows an example embodiment in a network 700. In this embodiment, PayPal Access is the identity provider (“IDP”) and Marketplace, Stubhub, Milo, and PayPal are the relying parties and service providers. As shown, each of the service providers may have a distinct user ID for the user, while having the same unique identifier (“UUID”) for the device being used to access the service. The dotted lines indicate that each service provider may communicate with the other service providers to gather information for the user. The service provider requesting information may identify the user by the UUID for the device, or by using an identity provided by the IDP. Either way, the service provider may gather information about the user aggregated from all of the service providers. For example, the correlation module 350 of FIG. 3 may perform this function.

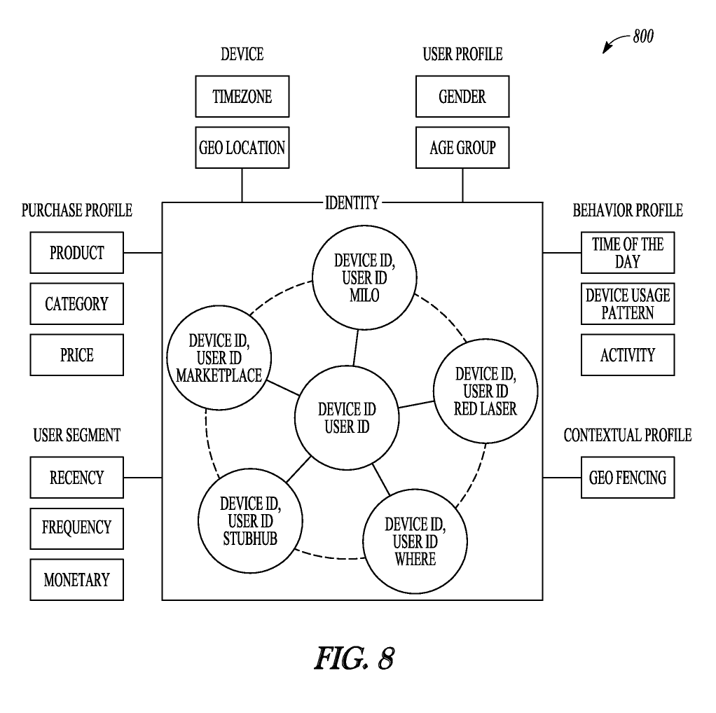

FIG. 8 is a block diagram illustrating data relationships in particular disclosed embodiments. The relationships may exist in a network 800. FIG. 8 additionally shows data that may be gathered about the user from various sources. For example, information about the recency and frequency of purchases, along with other financial or monetary data, may help identify the user segment. Likewise, information about products purchased, the categories those products fall in, and the price of those products may help identify a purchase profile of the user. Data may also be gathered from a mobile device used by the user that may be able to provide time zone and geo-location information about the user. The user may have user profiles with one or more of the services that may provide the gender and age group of the user. The user may have patterns of use that may be determined by tracking the user's access to the various service providers. For example, the user's usage pattern may be predictable based on the time of day, a pattern of access (e.g., accessing one service at the same time as accessing another service, or after a transaction on the other service has completed), or the location of the user (e.g., accessing certain services from one location that may correspond to a work location and other services from another location that may correspond to a home location).

Any of the machines, databases, or devices described herein may be used or configured, partially or entirely, as appropriate to perform one or more of the methods, operations, or functions described herein, or as set forth below in the following method steps. Other devices or systems may be employed. Some examples of the present disclosure include methods for the creation of federated user identities.

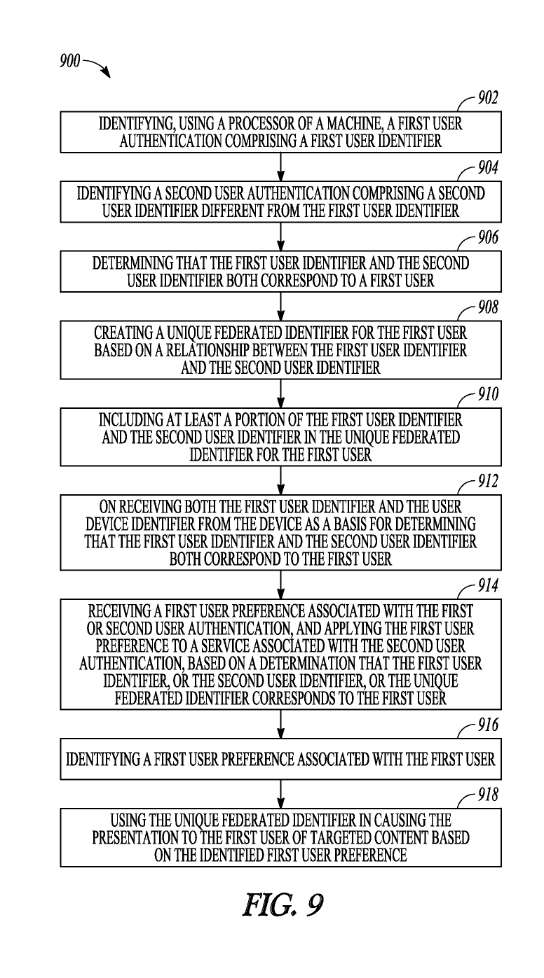

One such method is illustrated in FIG. 9. While the various operations of the method 900 are described in reference to the service providing machine 110a or 110b of FIG. 2 and the mobile identity machine 130 of FIG. 3, other devices or systems may be employed to perform the method 900 in other embodiments. In this example embodiment, a method 900 includes: at block 902, identifying, using a processor of a machine, a first user authentication comprising a first user identifier; at block 904, identifying a second user authentication comprising a second user identifier different from the first user identifier; at block 906, determining that the first user identifier and the second user identifier both correspond to a first user; and at block 908, creating a unique federated identifier for the first user based on a relationship between the first user identifier and the second user identifier.

The method 900 may further comprise: at block 910, including at least a portion of the first user identifier and the second user identifier in the unique federated identifier for the first user. In some examples, the first user identifier is associated with a user account number or property identifier, and the second user identifier includes a user device identifier.

In some examples, determining that the first user identifier and the second user identifier both correspond to the first user is based, at block 912, on receiving both the first user identifier and the user device identifier from the device. In some examples, the first user authentication is for a first service or account, and the second user authentication is for a second service or account.

The method 900 may further comprise: at block 914, receiving a first user preference associated with the first or second user authentication, and applying the first user preference to a service associated with the second user authentication based on a determination that the first user identifier, the second user identifier, or the unique federated identifier corresponds to the first user.

In some examples, the method 900 further comprises: at block 916, identifying a first user preference associated with the first user and, at block 918, using the unique federated identifier in causing the presentation to the first user of targeted content based on the identified first user preference.

According to various example embodiments, one or more of the methodologies described herein may facilitate identification of a user by a service provider. The identification of the user may allow the service provider to provide a more precisely tuned experience to the user. This enhanced user experience may provide the service provider with a competitive advantage. For example, items viewed by a user accessing an online retailer may be tracked and shared with other service providers, allowing advertising to be targeted. Similarly, categories searched, brands bought, optimal notification choices (e.g., preferred device, preferred time, preferred place), average price of items purchased, total amount recently spent (e.g., over the last week, month, quarter, or year) may all be tracked and shared with other service providers. As another example, a user that chose a preferred delivery method for one service provider may find that another service provider has pre-selected that delivery method as a default option, based on the shared user information from the user's mobile identity.

According to various example embodiments, one or more of the methodologies herein may facilitate identification of multiple devices associated with a user. The identification of the multiple devices may allow a service provider to direct communications more effectively. For example, if a user generally accesses a service from a laptop computer during the day and accesses the service from a mobile device at night, then a communication for the user may be directed to the laptop computer if sent during the daytime, and to the mobile device if sent at night.

According to various example embodiments, one or more of the methodologies herein may facilitate the detection of fraud. For example, if a user creates an unusually large number of accounts (e.g., two or more or five or more) for a particular service, this may suggest that the user is attempting to engage in a large number of simultaneous fraudulent transactions while avoiding having any individual account shut down due to numerous complaints. In another example, if fraud is detected on one account, preventative measures may be taken with respect to other accounts belonging to the same user.

FIG. 10 is a block diagram illustrating components of a machine 1000 able to read instructions from a machine-readable medium (e.g., a machine-readable storage medium, a computer-readable storage medium, or any suitable combination thereof) and perform any one or more of the methodologies discussed herein, according to some example embodiments. Specifically, FIG. 10 shows a diagrammatic representation of the machine 1000 in the example form of a computer system and within which instructions 1024 (e.g., software, a program, an application, an applet, an app, or other executable code) for causing the machine 1000 to perform any one or more of the methodologies discussed herein. In alternative embodiments, the machine 1000 operates as a standalone device or may be connected (e.g., networked) to other machines. In a networked deployment, the machine 1000 may operate in the capacity of a server machine or a client machine in a server-client network environment, or as a peer machine in a distributed (e.g., peer-to-peer) network environment. The machine 1000 may be a server computer, a client computer, a personal computer (PC), a tablet computer, a laptop computer, a netbook, a set-top box (STB), a personal digital assistant (PDA), a cellular telephone, a smartphone, a web appliance, a network router, a network switch, a network bridge, or any machine capable of executing the instructions 1024, sequentially or otherwise, that specify actions to be taken by that machine 1000. Further, while only a single machine is illustrated, the term “machine” shall also be taken to include a collection of machines that, individually or jointly, execute the instructions 1024 to perform all or part of any one or more of the methodologies discussed herein.

The machine 1000 includes a processor 1002 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 1004, and a static memory 1006, which are configured to communicate with each other via a bus 1008. The machine 1000 may further include a graphics display 1010 (e.g., a plasma display panel (PDP), a light emitting diode (LED) display, a liquid crystal display (LCD), a projector, or a cathode ray tube (CRT)). The machine 1000 may also include an alphanumeric input device 1012 (e.g., a keyboard), a cursor control device 1014 (e.g., a mouse, a touchpad, a trackball, a joystick, a motion sensor, or other pointing instrument), a storage unit 1016, a signal generation device 1018 (e.g., a speaker), and a network interface device 1020.

The storage unit 1016 includes a machine-readable medium 1022 on which is stored the instructions 1024 embodying any one or more of the methodologies or functions described herein. The instructions 1024 may also reside, completely or at least partially, within the main memory 1004, within the processor 1002 (e.g., within the processor's cache memory), or both, during execution thereof by the machine 1000. Accordingly, the main memory 1004 and the processor 1002 may be considered machine-readable media. The instructions 1024 may be transmitted or received over a network 1026 (e.g., network 190) via the network interface device 1020.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 1022 is shown in an example embodiment to be a single medium, the term “machine-readable medium” should be taken to include a single medium or multiple media (e.g., a centralized or distributed database, or associated caches and servers) able to store instructions 1024. As used herein, a “database” is a data storage resource and may store data structured as a text file, a table, a spreadsheet, a relational database (e.g., an object-relational database), a triple store, a hierarchical data store, or any suitable combination thereof. The term “machine-readable medium” shall also be taken to include any medium or combination of multiple media that is capable of storing instructions 1024 for execution by a machine (e.g., machine 1000), such that the instructions 1024, when executed by one or more processors of the machine (e.g., processor 1002), cause the machine 1000 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall, accordingly, be taken to include, but not be limited to, one or more data repositories in the form of a solid-state memory, an optical medium, a magnetic medium, or any suitable combination thereof.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or in any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may, accordingly, configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. However, these words are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

What is claimed is:

1. A system, comprising:
a memory;
a communication module to:
identify a first user authentication comprising a first user identifier;
identify a second user authentication comprising a second user identifier different from the first user identifier; and
an identification module to:
determine, using a processor of a machine, that the first user identifier and the second user identifier both correspond to a first user; and
create a unique federated identifier for the first user based on a relationship between the first user identifier and the second user identifier.

2. The system of claim 1, wherein:
the identification module is further configured to include at least a portion of the first user identifier and the second user identifier in the unique federated identifier for the first user.

3. The system of claim 1, wherein:
the first user identifier is associated with a user account number or a property identifier;
the second user identifier includes a user device identifier; and
wherein the determining by the identification module that the first user identifier and the second user identifier both correspond to the first user is based on receiving both the first user identifier and the user device identifier from a device.

4. The system of claim 1, wherein:
the first user authentication is for a first service or account; and
the second user authentication is for a second service or account.

5. The system of claim 1, wherein:
the communication module is further to receive a first user preference associated with the first or second user authentication; and
the identification module is further to apply the first user preference to a service associated with the second user authentication based on a determination that the first user identifier, the second user identifier, or the unique federated identifier corresponds to the first user.

6. The system of claim 1, wherein:
the communication module is further to identify a first user preference associated with the first user; and
the identification module is further to use the unique federated identifier in causing a presentation to the first user of targeted content based on the identified first user preference.

7. A method comprising:
identifying, using a processor of a machine, a first user authentication comprising a first user identifier;
identifying a second user authentication comprising a second user identifier different from the first user identifier;
determining that the first user identifier and the second user identifier both correspond to a first user; and
creating a unique federated identifier for the first user based on a relationship between the first user identifier and the second user identifier.

8. The method of claim 7, further comprising:
including at least a portion of the first user identifier and the second user identifier in the unique federated identifier for the first user.

9. The method of claim 7 wherein:
the first user identifier is associated with a user account number or property identifier;
the second user identifier includes a user device identifier; and
determining that the first user identifier and the second user identifier both corresponding to the first user is based on receiving both the first user identifier and the user device identifier from a device.

10. The method of claim 7 wherein:
the first user authentication is for a first service or account; and
the second user authentication is for a second service or account.

11. The method of claim 7, further comprising:
receiving a first user preference associated with the first or second user authentication; and
applying the first user preference to a service associated with the second user authentication based on a determination that the first user identifier, the second user identifier, or the unique federated identifier corresponds to the first user.

12. The method of claim 7, further comprising:
identifying a first user preference associated with the first user; and
using the unique federated identifier in causing a presentation to the first user of targeted content based on the identified first user preference.

13. A non-transitory machine-readable storage medium comprising instructions that, when executed by one or more processors of a machine, cause the machine to perform operations comprising:
identifying, using the processor of the machine, a first user authentication comprising a first user identifier;
identifying a second user authentication comprising a second user identifier different from the first user identifier;
determining that the first user identifier and the second user identifier both correspond to a first user; and
creating a unique federated identifier for the first user based on a relationship between the first user identifier and the second user identifier.

14. The non-transitory machine-readable storage medium of claim 13, wherein the operations further comprise:
including at least a portion of the first user identifier and the second user identifier in the unique federated identifier for the first user.

15. The non-transitory machine-readable storage medium of claim 13, wherein:
the first user identifier is associated with a user account number or property identifier;
the second user identifier includes a user device identifier; and
determining that the first user identifier and the second user identifier both corresponding to the first user is based on receiving both the first user identifier and the user device identifier from a device.

16. The non-transitory machine-readable storage medium of claim 13, wherein:
the first user authentication is for a first service or account; and
the second user authentication is for a second service or account.

17. The non-transitory machine-readable storage medium of claim 13, wherein the operations further comprise:
receiving a first user preference associated with the first or second user authentication; and
applying the first user preference to a service associated with the second user authentication based on a determination that the first user identifier, the second user identifier, or the unique federated identifier corresponds to the first user.

18. The non-transitory machine-readable storage medium of claim 13, wherein the operations further comprise:
identifying a first user preference associated with the first user; and
using the unique federated identifier in causing a presentation to the first user of targeted content based on the identified first user preference.
